(19) United States
(12) Patent Application Publication
(10) Pub. No.: US 2007/0079062 A1
(43) Pub. Date: Apr. 5, 2007

(54) Method and system for storage access management in IP network

(76) Inventors: Toui Miyawaki, Kawasaki (JP); Emiko Kobayashi, Yokohama (JP); Takeshi Ishizaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/283,871

(22) Filed: Nov. 22, 2005

(30) Foreign Application Priority Data
Oct. 4, 2005 (JP) 2005-291160

(51) Int. Cl. G06F 12/00

(52) U.S. Cl. 711/112

(57) ABSTRACT

In an IP-SAN, instead of the presence or absence of mount/unmount requests, the actual mount/unmount status of storages is determined by monitoring session information of the storage apparatus and communicated to a mount reservation server. Change of access status is communicated in an accurate and real-time manner to the user terminal or management server that uses disk resources. This solves a problem that stoppage of access cannot be detected when the presence or absence of access to the storage apparatus is determined only by the mount/unmount request. The invention also solves a problem that, when the mounting is broken down due to any failure, a computer requesting to use the disk resources cannot access the disk despite its mount request.

The present application is based on and claims priority of Japanese patent application No. 2005-291160 filed on Oct. 4, 2005, the entire contents of which are hereby incorporated by reference.

### BACKGROUND

The invention disclosed herein relates to storage access management, and more particularly to a method and system for storage access management in a storage area network (hereinafter referred to as “SAN”) using an internet protocol network (hereinafter referred to as “IP network”). A SAN using an IP network is hereinafter denoted as “IP-SAN”.

United States Patent Application Publication US 2004/0205293 (hereinafter referred to as Patent Document 1) discloses an invention of a storage control apparatus and method. When a disk array apparatus is subjected to a copy (backup) instruction between its logical volumes or access to its data, a mount request is issued from its host apparatus to the disk array apparatus to enable the access. A mount status corresponding to the mount/unmount request is determined to prevent any occurrence of unexpected data failure that data in the same logical volume is rewritten by different host apparatuses.

In the storage control apparatus described in the above Patent Document 1, the storage apparatus determines the presence or absence of user access based only on the mount/unmount request by a user terminal. However, in some cases, stoppage of user access cannot be detected, since the mount/unmount request is not always equivalent to the actual mount status.

For example, a computer system may use a method of causing a backup server to make a backup of data of a storage apparatus at a time when users do not access the storage apparatus. It is assumed that the disks on the user terminal and on the storage apparatus have already been in the mounted state.

Here, if the mounting is broken down due to any failure although no unmount request is issued, the storage apparatus cannot detect user access stoppage. This causes a problem that the backup server cannot mount the disk for backup operation, if it attempts to do so, because the disk is determined as being user-accessed.

In order to solve the above problem, the computer system needs to have a mechanism of monitoring the actual mount/unmount status of storages rather than the presence or absence of mount/unmount requests to monitor the change of access status in an accurate and real-time manner and to communicate it to the user terminal or management server that exclusively uses disk resources.

### SUMMARY

According to one embodiment of the invention, a storage area network using an IP network (IP-SAN) includes a mount reservation server for monitoring/controlling mounting of storage apparatuses. The storage apparatus obtains storage session information to monitor the user access status. When any change of the access status occurs, the content of the status change is communicated to the mount reservation server. In response, the mount reservation server compares the content with mount requests that it has already received and saved from computers requesting mounting. Based on the comparison, mount reservations from the computers are fulfilled for only those disk resources where user access thereto has stopped. As a result, mount management in response to the change of the access status is achieved in an accurate and real-time manner.

According to one embodiment of the invention, the mount status of storages in a storage area network using an IP network can be monitored in an accurate and real-time manner, which allows for efficiently performing regular operation and management services such as backup and virus check services.

### BRIEF DESCRIPTION OF THE DRAWINGS

FIG. 1 is a system configuration diagram of an IP-SAN in Example 1 of the invention.

FIG. 2 is a function module diagram of the access status monitoring module in Example 1 of the invention.

FIG. 3 is a function module diagram of the iSCSI mount reservation module in Example 1 of the invention.

FIG. 4 is a process flow of the access status monitoring module in Example 1 of the invention.

FIG. 5 is a process flow of the iSCSI mount reservation module in Example 1 of the invention.

FIG. 6 shows examples of various files in Example 1 of the invention.

FIG. 7 is a conceptual diagram of scopes in Example 3 of the invention.

FIG. 8 shows examples of the scope definition files in Example 3 of the invention.

FIG. 9 shows an example of the session information file in Example 1 of the invention.

### DETAILED DESCRIPTION OF THE PREFERRED EMBODIMENTS

Embodiments of the invention will now be described in detail with reference to the drawings.

### EXAMPLE 1

Example 1 of the invention relates to an efficient computer system that directly couples a user terminal with a storage apparatus. A backup service is automatically performed at an administrator site at a time when the user terminal is not accessing the storage apparatus.

It should be noted that the embodiment of the invention is applicable to any forms of IP-SANs.

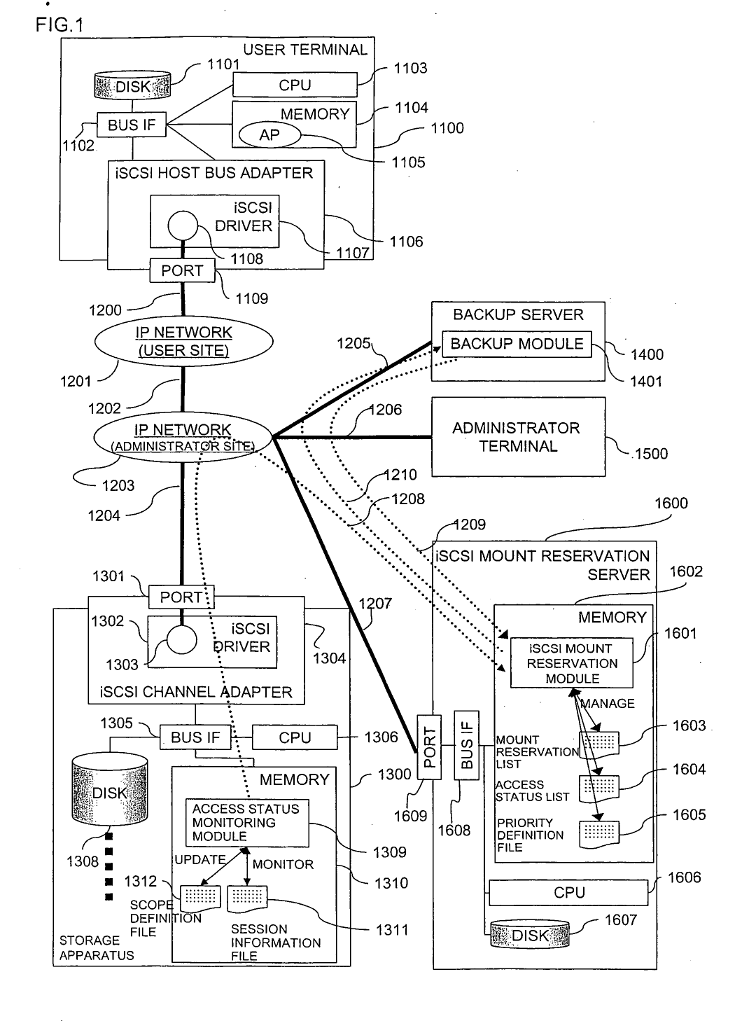

FIG. 1 shows the system configuration of an IP-SAN according to Example 1 of the invention.

A user terminal 1100 is connected to a user site IP network 1201. The user terminal 1100 has a disk 1101, a CPU 1103, and a memory 1104 that are linked via a bus IF 1102. The CPU 1103 launches an application 1105 on the memory 1104 for performing control. An iSCSI host bus adapter 1106 for connection to the user site IP network 1201 has an iSCSI initiator 1108 operating on an iSCSI driver 1107 and is connected to the user site 1201 via a port 1109 and a line 1200 of the IP network.

The user site IP network 1201 is connected to an administrator site IP network 1203 via a line 1202 of the IP network. The user site IP network 1201 and the administrator site IP network 1203 may be different networks, or may be the same network. Alternatively, the user site IP network 1201 and the administrator site IP network 1203 can be configured as a single IP network.

A storage apparatus 1300 is connected to the administrator site IP network 1203. The storage apparatus 1300 has one or more disks 1308, a CPU 1306, and a memory 1310 that are linked via a bus IF 1305. The memory 1301 maintains an access status monitoring module 1309, a session information file 1311, and a scope definition file 1312. The CPU 1306 launches the access status monitoring module 1309 on the memory 1310 to monitor the session information file 1311 and update the scope definition file 1312, thereby monitoring the access status.

Here, the scope definition refers to the scope of disk resources on the storage apparatus to which computers have access. The scope definition file 1312 is a file for defining monitoring policies for use in monitoring the session information file 1311 by the access status monitoring module 1309. The monitoring policies include, for example, the scope of disk resources in units of storages, volumes, or user-defined groups, the release of which triggers an access status change message 1208 to be transmitted to an iSCSI mount reservation server 1600.

An iSCSI channel adapter 1304 for connection to the administrator site IP network 1203 has an iSCSI target 1303 operating on an iSCSI driver 1302 and is connected to the administrator site IP network 1203 via a port 1301 and a line 1204 of the IP network.

A backup server 1400 including a backup module 1401 and an administrator terminal 1500 serving as an operation terminal for the iSCSI mount reservation server 1600 are connected to the administrator site via lines 1205 and 1206 of the IP network, respectively.

The iSCSI mount reservation server 1600 is connected to the administrator site via a line 1207 of the IP network and a port 1609. The iSCSI mount reservation server 1600 has a disk 1607, a CPU 1606, and a memory 1602 that are linked via a bus IF 1608. The memory 1602 maintains an iSCSI mount reservation module 1601, a mount reservation list 1603, an access status list 1604, and a priority definition file 1605. The CPU 1606 launches the ISCSI mount reservation module 1601 on the memory 1602 to read and/or write the information in the access status list and in the mount reservation list 1603 for mount control.

Here, by communicating with the iSCSI driver 1302, the access status monitoring module 1309 operating on the memory 1310 of the storage apparatus 1300 continuously or periodically obtains the latest session information, continuously or periodically monitors the session information file 1311 created on the basis of the obtained session information, and checks whether any change has occurred in the session information. When no change has occurred, nothing is performed. At the time when any change has occurred, an access status change message 1208 including the present time and the session information is transmitted to the iSCSI mount reservation server 1600.

In Example 1 of the invention, the message is transmitted only when any change has occurred in the user access status resulted from analysis of the storage sessions. Therefore the load of administrative traffic placed on the network can be minimized.

Example 1 of the invention is illustrated in the case where the session information 1311 and the scope definition file 1312 are located on the memory 1310. However, the session information 1311 may be located on the memory 1310 of the same machine, on the disk 1308, or on the iSCSI channel adapter 1304.

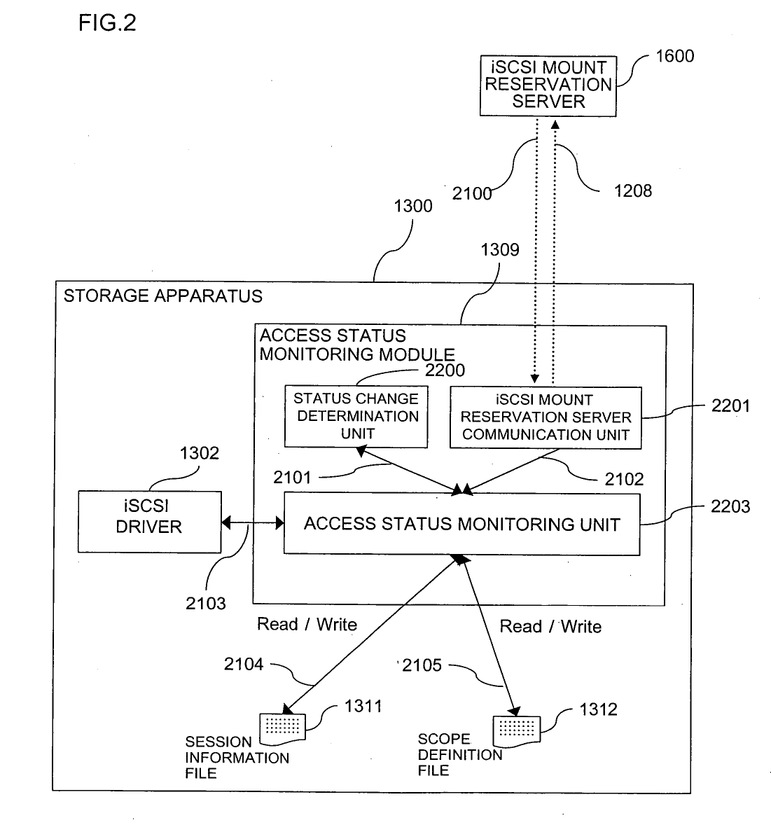

FIG. 2 shows a module configuration diagram of the access status monitoring module 1309 operating on the storage apparatus 1300. There is no limitation on the physical location of the access status monitoring module 1309 as long as it can communicate with the ISCSI mount reservation server 1600 and the iSCSI driver 1302.

The access status monitoring module 1309 comprises a status change determination unit 2200, an iSCSI mount reservation server communication unit 2201, and an access status monitoring unit 2203, and performs a series of processes for monitoring the access status under the control of the access status monitoring unit 2203.

The access status monitoring unit 2203 obtains session information by continuously or periodically communicating with the iSCSI driver 1302 (step 2103) and maintains the obtained session information as a session information file 1311. The access status monitoring unit 2203 manages not only iSCSI sessions being currently in communication but also iSCSI sessions being created earlier but already discarded (step 2104).

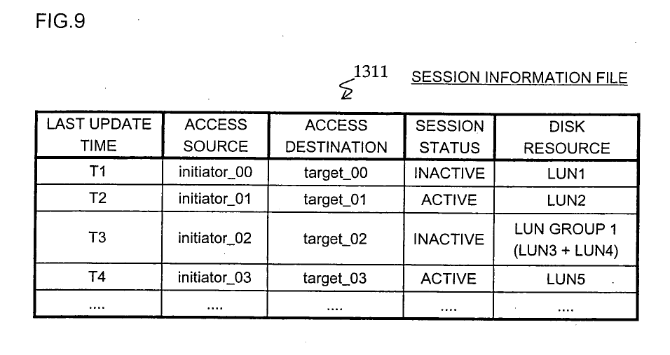

FIG. 9 shows an example of the session information file.

The session information file 1311 comprises information of the last update time of the session information, information of the name of the iSCSI initiator serving as the access source, information of the name of the iSCSI target serving as the access destination, information of the current session status as to whether the session is active or inactive, and information for uniquely identifying the disk resource to which the iSCSI target has access such as a Logical Unit Number (hereinafter referred to as LUN) or an identifier assigned to a grouping of LUNs. Therefore one or more than one disk resources may be allocated to a single session.

Specifically, in the iSCSI protocol, a session identification (SSID) is defined that indicates the status of a session between the iSCSI initiator serving as the access source and the iSCSI target serving as the access destination. The session identification (SSID) that specifies a storage apparatus as an iSCSI target can be used as the storage session information.

More specifically, the access status monitoring unit 2203 in the access status monitoring module 1309 placed in the storage apparatus 1300 can continuously or periodically communicate with the iSCSI driver 1302 in the iSCSI channel adapter 1304 placed in the storage apparatus 1300 to obtain, as the storage session information, a session identification symbol (SSID) created between the iSCSI initiator 1108 in the iSCSI host bus adapter 1106 placed in the user terminal 1100 and the iSCSI initiator 1303 (which serves as the iSCSI target in this case) in the iSCSI channel adapter 1304 placed in the storage apparatus 1300.

Example 1 of the invention illustrates a computer and a storage apparatus interconnected via the IP network using the iSCSI protocol. However, when an IP-SAN is configured by employing an IP network protocol other than the iSCSI protocol, session information corresponding to the employed IP network protocol can be used as the storage session information instead of the above-described session information (SSID) in the ISCSI protocol.

As described above, in Example 1 of the invention, aggregated storage sessions can be efficiently retrieved by obtaining storage session information at the storage apparatus side rather than at the computer side. Furthermore, the management system can be aggregated at the administrator site. Therefore, by using this means for obtaining the storage session status, processing efficiency can be improved and network load can be minimized.

On the other hand, the access status monitoring unit 2203 uses the iSCSI mount reservation server communication unit 2201 to receive the latest scope definition message 2100 transmitted from the iSCSI mount reservation server 1600. Based on this information, the access status monitoring unit 2203 creates a scope definition file 1312, and updates the scope definition file 1312 each time a new scope definition message 2100 is received.

Furthermore, the access status monitoring unit 2203 uses the status change determination unit 2200 to determine whether any change has occurred in the information of the session information file 1311. When any change has occurred as compared to earlier iSCSI sessions, the access status monitoring unit 2203 uses the iSCSI mount reservation server communication unit 2201 to transmit an access status change message 1208 to the iSCSI mount reservation server 1600.

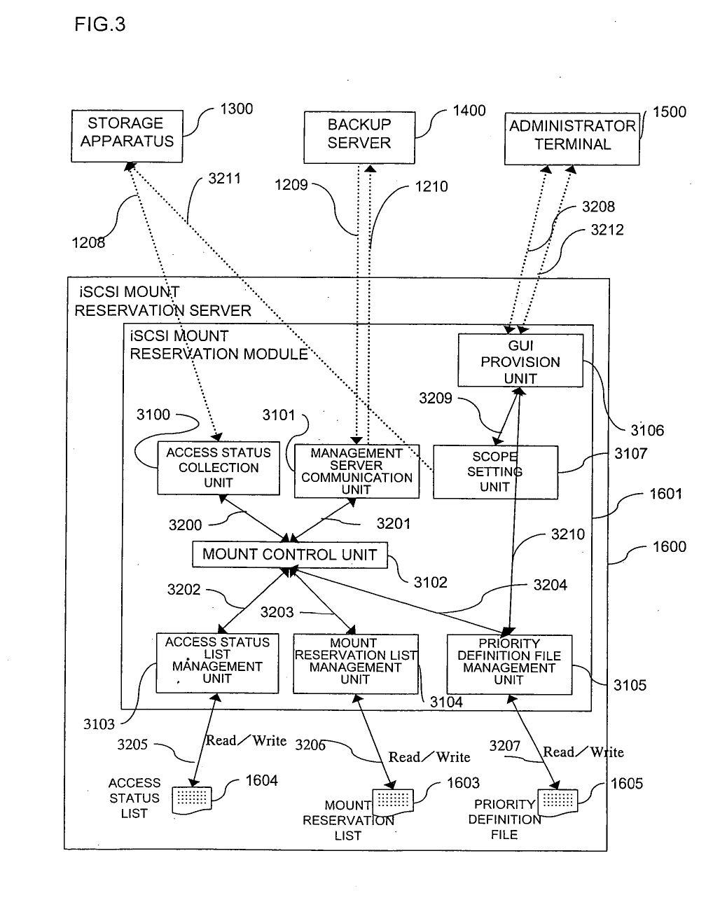

FIG. 3 is a function module diagram showing the configuration of the iSCSI mount reservation module 1601 operating on the iSCSI mount reservation server 1600. There is no limitation on the physical location thereof as long as it can communicate with each apparatus in the IP-SAN.

The iSCSI mount reservation module 1601 comprises an access status collection unit 3100, a management server communication unit 3101, a mount control unit 3102, an access status list management unit 3103, and a mount reservation list management unit 3104. The feature of each function module is described in the following.

The access status collection unit 3100 is a module for receiving an access status change message 1208 from the storage apparatus 1300 to obtain the change of user access status and for communicating it to the mount control unit 3102. FIG. 1 shows only a single storage apparatus, but in practice, messages from a plurality of storage apparatuses are aggregated and transmitted as an access status change notification message 3200 to the mount control unit 3102.

The management server communication unit 3101 receives a mount request message 1209 from a management server and transmits a mount request message 3201 to the mount control unit 3102 in conjunction with information of the IP address or host name of the management server and information of the time of receipt of the mount request and of the time desired for mounting. FIG. 1 shows only a single backup server, but in practice, messages from a plurality of back up servers are aggregated and transmitted as a mount request message 3201 to the mount control unit 3102.

The mount control unit 3102 is a module that reads and/or writes the information of the access status list and the information of the mount reservation list 1603 as needed in response to receiving the access status change notification message 3200 from the access status collection unit 3100 or the mount request message 3201 from the management server communication unit 3101. The mount control unit 3102 thereby permits mounting by transmitting amount permission message 1210 in response to the mount request by the backup server 1400 when the disk resource is released from the user.

In response to receiving the access status change notification message 3200 from the access status collection unit 3100, the mount control unit 3102 communicates the content of the access status change as an access status change instruction 3202 to the access status list management unit 3103.

Upon receipt thereof, the access status list management unit 3103 performs update 3205 of the access status list in accordance with the latest access status. Here, when the access status transitions from access-in-progress to access-stopped, the mount control unit 3102 issues a reservation content search instruction 3203 to the mount reservation list management unit 3104.

The mount reservation list management unit 3104 makes a search (3206) to determine whether the mount reservation list 1603 includes a mount request for the disk resource that has a user access status having transitioned from access-in-progress to access-stopped. If so, the mount reservation list management unit 3104 notifies the mount control unit 3102 accordingly by sending a response thereto. Upon receipt thereof, the mount control unit 3102 transmits a mount permission message 1210 to the backup server 1400 via the management server communication unit 3101. In response to receiving the mount permission message 1210, the backup server 1400 automatically launches a backup service upon completion of mounting the disk resource of interest and performs a process of backup to a secondary storage apparatus 1400.

A priority definition file management unit 3105 receives (step 3210) a priority definition 3208 via a GUI provision unit 3106. The priority definition 3208 is inputted from the administrator terminal 1500 via a GUI screen provided by the GUI provision unit 3106. The priority definition file management unit 3105 updates the priority definition file 1605 in accordance with the content of the received priority definition 3208. Furthermore, the above GUI can be used to confirm the latest priority definition from the administrator terminal 1500.

The scope setting unit 3107 receives (step 3209) a scope definition 3212 via the GUI provision unit 3106. The scope definition 3212 is inputted from the administrator terminal 1500 via a GUI screen provided by the GUI provision unit 3106. The scope setting unit 3107 creates a scope definition message 3211 in accordance with the received information and transmits it to the storage apparatus 1300. Furthermore, the above GUI can be used to confirm the latest scope definition for each storage apparatus by inputting unique information on the storage apparatus such as its IP address or host name.

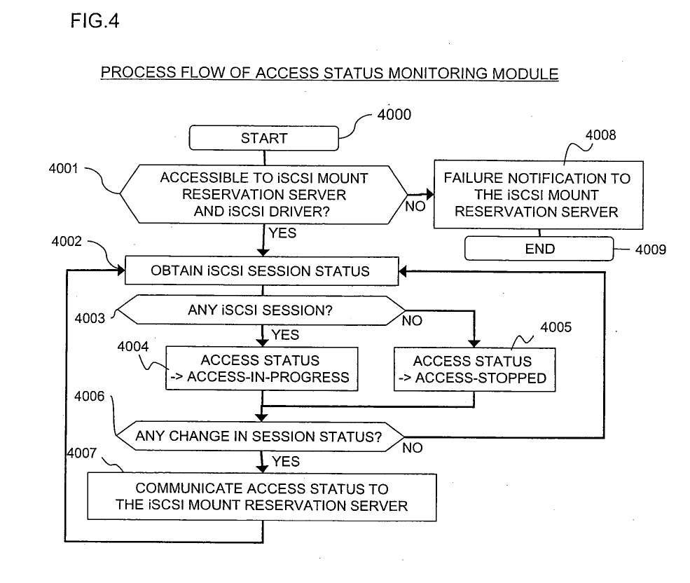

FIG. 4 shows a basic process flow of the access status monitoring module 1309. When the access status monitoring module 1309 is launched on the storage apparatus 1300 (step 4000), the access status monitoring module 1309 checks the availability of communication with the mount reservation server 1600 and the iSCSI driver 1302 (step 4001). When there is any unavailable access, failure notification to the iSCSI mount reservation server 1600 is performed (step 4008) and the access status monitoring module 1309 is stopped (step 4009). When access is available at step 4001, the session information 1310 of iSCSI sessions is obtained (step 4002).

The access status monitoring module 1309 searches the obtained iSCSI session information 1310 to check whether any iSCSI session is currently created between the iSCSI initiator 1108 and the iSCSI target 1303 (step 4003). When any iSCSI session has already been created, the access status is set to access-in-progress (step 4004). When no iSCSI session has been created yet, the access status is set to access-stopped (step 4005). At this time, the last access status is compared to check whether any change occurs (step 4006). When no change occurs, control directly returns to step 4002 to continue the process. When any change occurs, the changed access status is transmitted to the iSCSI mount reservation server 1600 (step 4007) and control returns to step 4002 to continue the above process.

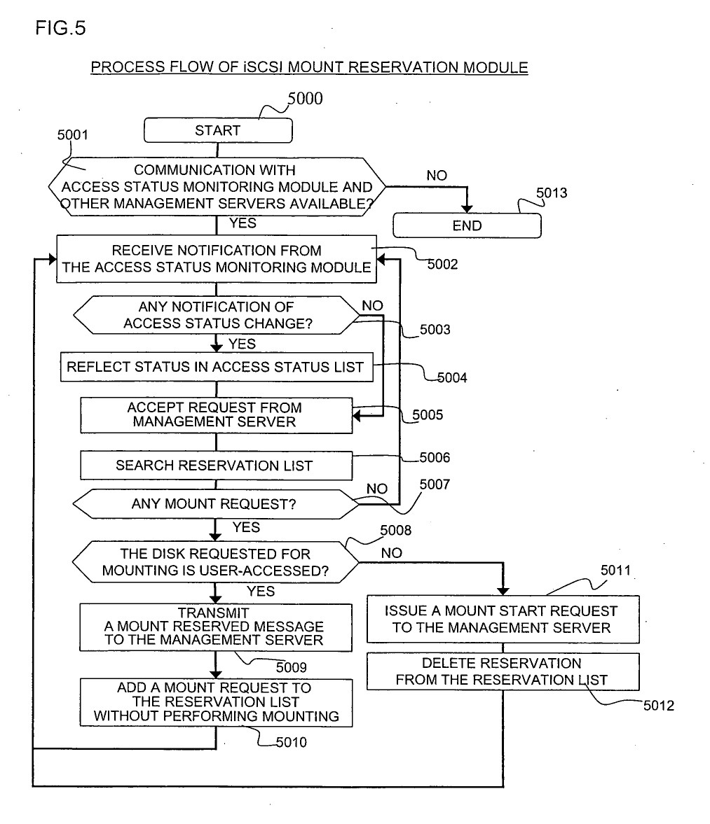

FIG. 5 shows a basic process flow of the iSCSI mount reservation module 1601. When the iSCSI mount reservation module 1601 is launched on the iSCSI mount reservation server 1600 (step 5000), the iSCSI mount reservation module 1601 checks the availability of communication with the access status monitoring module 1309 and other servers (backup server 1400 in this Example) (step 5001). When there is any unavailable communication, the iSCSI mount reservation module 1601 is stopped (step 5013). When communication is available, it is confirmed whether there is any notification from the access status monitoring module 1309, and if so, it is received (step 5002).

In Example 1 of the invention, the change of access status is obtained by receiving notification from the access status monitoring module 1309. Alternatively, the iSCSI mount reservation module 1601 may take control of periodically fetching the latest session status from the storage apparatus 1300.

However, the method of receiving notification from the access status monitoring module 1309 as illustrated in Example 1 of the invention can minimize the load placed on the network because the notification is triggered by the change of access status.

The process is continued in accordance with the presence or absence of the notification of the access status change (step 5003). When there is any notification, the content thereof is reflected in the access status list 1604 (step 5004) and the process is continued to step 5005. When there is no notification, the process is directly continued to step 5005. At step 5005, a mount request message 1209 from the management server is accepted. Furthermore, the mount reservation list is searched to determine whether any mount request is reserved (step 5006). Specifically, it is determined whether there is any real-time mount request or any request in the mount reservation list (step 5007). When either of the requests is present, the access status list is searched to check whether the disk requested for mounting is being user-accessed (step 5008). If so, no mount process is performed and a message is transmitted to the management server (step 5009) for informing that mounting is currently unavailable and the requested mount is reserved. A mount request is then added to the mount reservation list 1603 (step 5010) and control returns to step 5002 to continue the above process.

When neither of the mount requests is present, control directly returns to step 5002. On the other hand, when user access is stopped, a mount permission message 1210 is issued to the management server (step 5011). Upon receipt thereof, the backup server 1400 performs a mount process on the disk 1308 of the storage apparatus 1300. When the mount process is completed, a process of backup from the disk 1308 to the disk 1401 of the secondary storage apparatus 1400 is performed.

The ISCSI mount reservation module 1601 issues a mount permission message 1210 and deletes the permitted reservation of the backup server 1400 from the mount reservation list 1603.

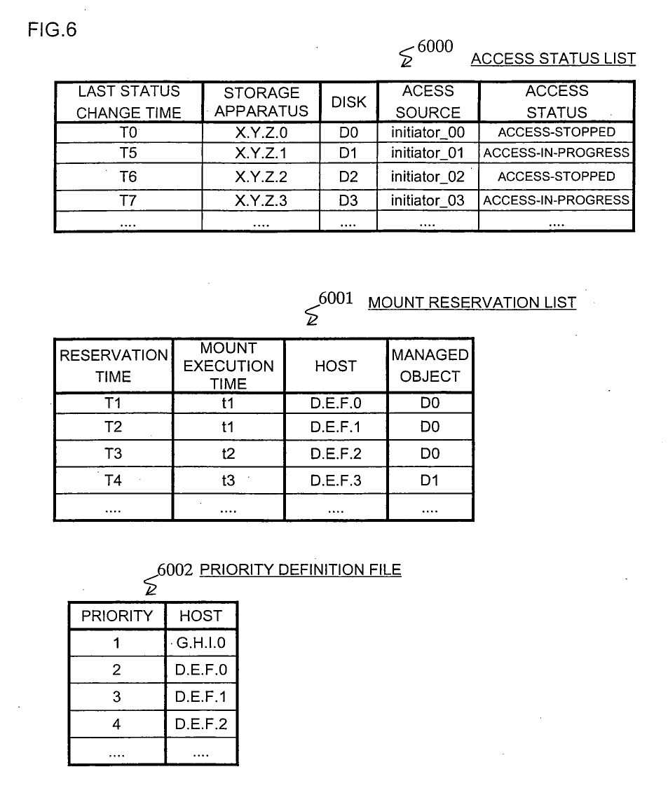

FIG. 6 shows an example format of various files.

Reference numeral 6000 denotes an example of the access status list. The access status list 6000 is composed of a last status change time column, a storage apparatus column, a disk column, an access source column, and an access status column. The information in the last status change time column is the last time when the access status monitoring module 1309 detected the status change from the session information 1310. The information in the storage apparatus column is the unique information for uniquely identifying the storage apparatus, which may be the IP address or host name of the storage apparatus. The information in the disk column is the unique information for uniquely identifying the disk in the above storage apparatus, which may be a physical disk number, a logical disk number, or a number assigned to a grouping of physical or logical disks. The information in the access source column is the name of the iSCSI initiator of a user terminal, management server, or storage apparatus serving as an access source. The information in the access status column indicates whether the access source apparatus is accessing the associated disk resource or such access is stopped.

Reference numeral 6001 denotes an example of the mount reservation list. The mount reservation list 6001 is composed of a reservation time column, a mount execution time column, a host column, and a managed object column. The information in the reservation time column is the time when the iSCSI mount reservation server 1600 received a mount request message 1209 transmitted by the management server such as the backup server 1400. The information in the mount execution time column is the time when the management server such as the backup server 1400 desires to actually start a mount process.

The information in the host column uniquely identifies a host such as the backup server 1400, and may be the IP address or host name of the host. The information in the managed object column uniquely identifies a managed disk resource, and may be a physical disk number, a logical disk number, or a number assigned to a grouping of physical or logical disks.

Reference numeral 6002 denotes an example of the priority definition file. The priority definition file 6002 is composed of a priority column and a host column. The priority column defines which disk is given priority in application of management service. For example, the smaller the value in this column, the higher the priority. The information in the host column may be the IP address or host name, which serves for uniquely identifying each host such as a user terminal or management server.

With reference to the process flow, the following describes how the files shown in FIG. 6 are actually used.

In the process flow of the iSCSI mount reservation server 1600 shown in FIG. 5, the ISCSI mount reservation server 1600 waits for a mount request by the management server at step 5005. Assume, for example, that no mount request is received at this time. Even when there is no real-time mount request, the iSCSI mount reservation server 1600 searches the mount reservation list 1603 at step 5006 in order to examine whether there was any mount request in the past. It is assumed that the iSCSI mount reservation server 1600 has consequently obtained the reservation contents shown in the mount reservation list 6001 of FIG. 6.

The mount reservation list 6001 includes two contents reserved for execution at current time t1. The first one, which was reserved at time T1, is a request that the backup server 1400, or a host with IP address D.E.F.0, desires to mount the disk 1308 at time tl. The second one, which was reserved at time T2, is a request that a host with IP address D.E.F.1, desires to mount the disk 1308 at time t1.

It is assumed here that the host with IP address D.E.F.0 is the backup server 1400 and that the host with IP address D. E. F. 1 is another management server. It is also assumed that the current time is t1 and that the time T1 is earlier than the time T2. Since the former reservation is reserved earlier than the latter reservation, the former reservation is selected as a candidate for mount permission in favor of the reservation time. In this case, the mount request by the backup server 1400 is prioritized and selected as a candidate for mount permission.

On the other hand, if T1 and T2 are an equal time, the priority of the host having IP address D.E.F.0 is compared to the priority of the host having IP address D.E.F.1 that are described in the priority definition file 6002 preprogrammed by the administrator. The former host is selected as a candidate for mount permission because it has a higher priority. In this case, the mount request by the user terminal 1100 is prioritized and selected as a candidate for mount permission.

Furthermore, in order to determine whether the host selected as a candidate for mount permission is actually accessible to disk resources, the iSCSI mount reservation server 1600 checks at step 5008 whether the disk requested for mounting is being user-accessed. As a result, for example, the access status as illustrated in the access status list 6000 of FIG. 6 is obtained. It is assumed here that time T0 is earlier than T1. It can be seen that access from the user terminal 1100 to the disk 1308, which the backup server 1400 selected as a candidate for mount permission intends to have access, is stopped at time T0, earlier than time T1 at which mounting is to be performed, and that the disk resource is currently released. Consequently, the iSCSI mount reservation server 1600 transmits a mount permission message 1210 to the backup server 1400 to permit mounting of the disk 1308.

The example described so far is the case where the backup server is used as a management server.

Next, an example is described that is applicable not only to the backup server but also to any hosts (user terminal, management server, etc.) competitively sharing disk resources. The following describes an example of using a virus check server as a management server.

Use of a virus check server as a management server only replaces the backup server 1400 in FIG. 1 with the virus check server, leaving the basic configuration of the system unchanged. Furthermore, the data flow and the managed information are also left unchanged because the basic function of the mount reservation server 1600 is to grant mount permission to management servers in response to the actual user access status. Therefore, in a similar manner to the case where the backup server is used, the virus check server mounts any of the disks in the storage apparatus 1300 at a time when users are not affected, and performs a virus check service.

Example 1 of the invention is directed to a form of computer system in which the user terminal is directly coupled to the storage apparatus. However, the invention is applicable to any forms of computer systems. As an example, the invention is directly applicable to a computer system via a diskless blade, which is described in the following.

In FIG. 1, imagine a system configuration where a diskless blade is connected to the user site IP network 1201 portion between the user terminal. 1100 and the storage apparatus 1300. Typically, in this system configuration, the user terminal 1100 and the diskless blade communicate with each other via the IP protocol, and the diskless blade and the storage apparatus 1300 communicate with each other via the iSCSI protocol. Therefore the locational relationship is changed only in that the diskless blade corresponds to the user terminal 1100 in the above-described Example 1 using the backup server. The basic configuration is thus left unchanged and the invention is applicable.

### EXAMPLE 2

In Example 2 of the invention, in response to receipt of a connection request by a user, an already mounted disk resource is released to the user terminal to permit access thereby.

When it is desired to prioritize a mount request by the user terminal over a mount request by the management server, the priority of the user terminal is preprogrammed to be higher as shown in the priority definition file 6002 of FIG. 6.

In Example 2 of the invention, the priority shown in the priority definition file 6002 is used. For example, even if the management server has already mounted a disk and is running any management service, the ISCSI mount reservation module 1601 transmits a message to the management server for transmitting an unmount request when a mount request is received from the user terminal 1100, since the mount request by the user terminal has a higher priority. At the same time, a mount permission message 1210 is transmitted to the user terminal 1100 to restore the user terminal 1100 to the state of mounting the storage apparatus 1300.

Consequently, the management service can be performed in the administrator site IP network 1203 when users do not access the storage apparatus. Upon a mount request by a user, the storage apparatus can be unmounted at the management server side and restored to the mounted state at the user side. Therefore the management service can be performed without affecting the user.

In this way, the mount status can be monitored in an accurate and real-time manner, which allows for efficiently performing regular operation and management services such as backup and virus check services. Furthermore, maintenance operations such as replacement of disks or storage apparatuses can be started at a time that has definitely no influence on user access.

### EXAMPLE 3

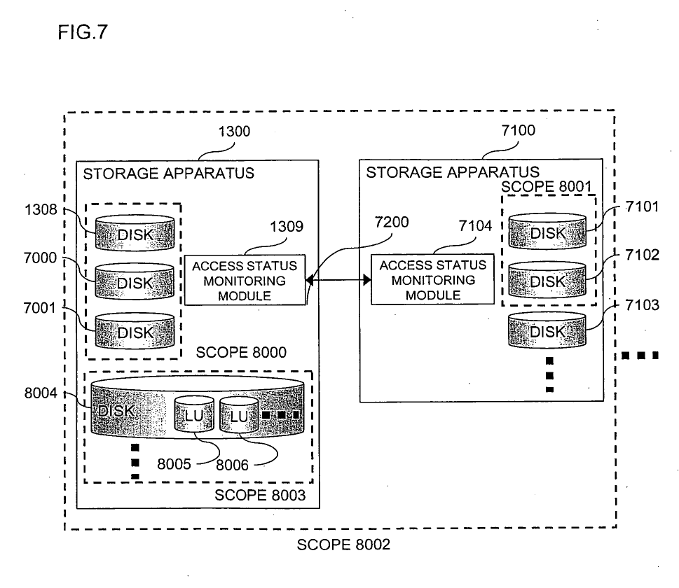

Example 3 of the invention is directed to using the scope definition file 1312 to monitor the access status when, as shown in FIG. 7, a plurality of storage apparatuses including a storage apparatus 7100 other than the storage apparatus 1300 are connected to the administrator site IP network 1203.

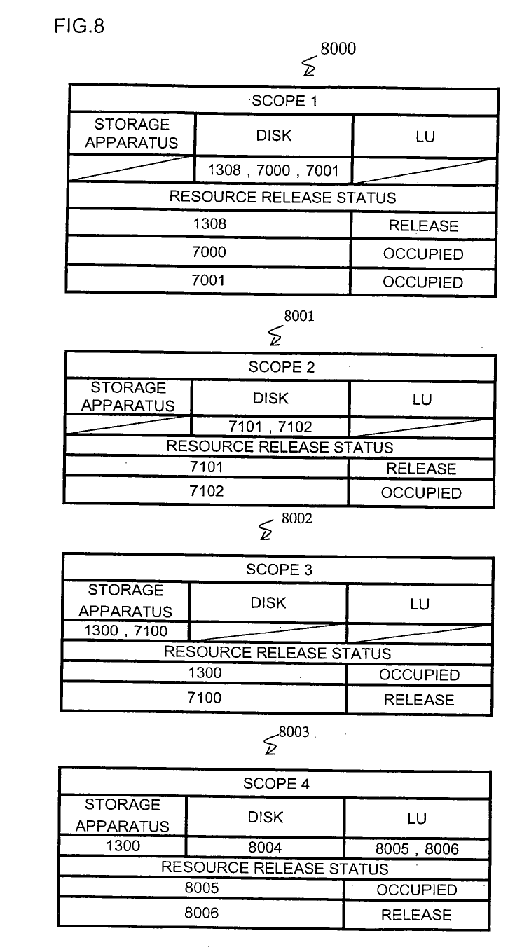

Here, the scope definition file 1312 can be defined from various viewpoints as shown in FIG. 8.

In a scope definition file 8000, disks 1308, 7000, and 7001 in the storage apparatus 1300 are defined as a group of disk resources. In another scope definition file 8001, disks 7101 and 7102 in the storage apparatus 7100 are defined as a group of disk resources.

In still another scope definition file 8002, the storage apparatuses 1300 and 7100 are defined as a group of disk resources. Each scope definition file has not only the definition of scope but also the information of the resource release status indicating whether individual disk resources constituting the scope are released or occupied.

In addition to this information of the resource release status, the scope definition file can describe the correspondence relationship between storage apparatuses and disks as well as between disks and logical volumes (hereinafter referred to as LU).

Resources may be represented in units of storage apparatuses including both LUs and disks as in the scope 8002, in units of disks including LUs as in the scopes 8000 and 8001, or in units of LUs constituting the disks as in the scope 8003. The scope definition file can be defined in any of these units. The resource release status in the scope definition file is maintained for a minimum unit of resources.

When the unit accessed from the host computer is different from the unit of the monitored object, the access status monitoring module 1309 refers to the minimum unit of resources defined in the scope definition file. In the example of the scope definition file 8003, the minimum unit of resources is LU. At a time when resources of this minimum unit are entirely occupied or released, the release status is switched to occupied or released. In this way, even if user access is processed in units of LUs and monitoring is processed in units of disks, for example, a resource is regarded as being released at the time of entire release of the LUs included in the monitored disks. Therefore storage access is properly managed.

Irrespective of which of the scope definition files 8000, 8001, and 8002 is used for definition, the access status monitoring module 1309, 7104 confirms whether the scope has a definition involving different storage apparatuses. If there is any definition involving different storage apparatuses, the access status monitoring modules 1309, 7104 located in the respective storage apparatuses communicate with each other via the administrator site IP network 1203 to exchange information of the scope definition file continuously or periodically, thereby keeping the release status of the entire group of disk resources up to date.

Only when all the elements of disk resources defined in a scope are released, the access status monitoring module 1309 transmits an access status change message 1208 to the iSCSI mount reservation server 1600.

It is assumed that among the installed access status monitoring modules, the last access status monitoring module 1309 that detected release of the entire resources actually transmits the access status change message 1208.

This allows for transmitting an access status change message 1208 at a time when a group of disk resources predetermined as a scope is entirely released instead of transmitting an access status change message 1208 for every change of access status. Therefore the load of administrative traffic placed on the network can be minimized.

What is claimed is:

1. A storage access management method in a system including a plurality of computers connected to one or more storage apparatuses via an IP network, the method comprising:
collecting storage session information from each storage apparatus; and
based on the storage session information, when disk resources used by a computer are released, performing mount control for permitting other computers to mount the disk resources.

2. A storage access management method according to claim 1, further comprising:
obtaining the storage session information located in the storage apparatus;
monitoring access status of the storage apparatus; and
communicating change of the access status to a mount reservation server.

3. A storage access management method according to claim 1, further comprising:
monitoring storage session information located in the storage apparatus to determine access status to be access-in-progress when the storage session information is present and to determine the access status to be access-stopped when the storage session information is absent.

4. A storage access management method according to claim 1 further comprising:
in response to change of the access status, transmitting a message to a mount reservation server, the message containing the access status, information of an access source computer, information of an access destination storage apparatus, and date and time of the change of the access status.

5. A storage access management method according to claim 1, wherein the storage apparatus is operative for:
receiving a scope definition transmitted from a mount reservation server, the scope definition defining a scope of disk resources,
monitoring the storage session information in accordance with the scope definition, and
in response to change of the access status, transmitting the storage session information to the mount reservation server.

6. A storage access management method according to claim 1, wherein
the mount control permits mount requests in ascending order of reservation time.

7. A storage access management method according to claim 1, wherein
the mount control accepts a priority of mounting for each computer or for each disk resource from a predetermined computer and permits mount requests in order of decreasing priority in accordance with the priority that has been preprogrammed.

8. A storage access management method according to claim 1, further comprising:
determining whether the disk resource is released; and
refusing mounting of the disk resource to other computers when the disk resource is not released.

9. A storage access management system for use in a storage area network in which a plurality of computers are connected to one or more storage apparatuses via an IP network, the system comprising:
one or more storage apparatuses obtaining storage session information and transmitting it to a mount reservation server; and
a mount reservation server that, based on the storage session information collected from each storage apparatus, only when disk resources used by a computer are released, performs mount control for permitting other computers to mount the disk resources.

10. A storage access management system according to claim 9, wherein the storage apparatus is operative for:
obtaining the storage session information,
monitoring access status of the storage apparatus, and
communicating change of the access status to the mount reservation server.

11. A storage apparatus connected to a plurality of computers via an IP network and constituting a storage area network, the storage apparatus comprising:
at least one disk, a CPU, and a memory that are linked via a bus, the CPU launching an access status monitoring module on the memory to obtain storage session information located in the storage apparatus, to monitor access status of the storage apparatus, and to communicate change of the access status to a mount reservation server.

12. A storage apparatus according to claim 11, wherein
the CPU monitors storage session information located in the storage apparatus to determine access status to be access-in-progress when the storage session information is present and to determine the access status to be access-stopped when the storage session information is absent.

13. A storage apparatus according to claim 11, wherein
the CPU transmits a message to the mount reservation server in response to the change of the access status, the message containing the access status, information of an access source computer, information of an access destination storage apparatus, and date and time of the change of the access status.

14. A storage apparatus according to claim 11, wherein the CPU is operative for:
receiving a scope definition transmitted from the mount reservation server, the scope definition defining a scope of disk resources,
monitoring the storage session information in accordance with the scope definition, and
communicating change of the access status to the mount reservation server.

15. A mount reservation server connected to a storage area network in which a plurality of computers are connected to one or more storage apparatuses via an IP network, the mount reservation server comprising:
at least one disk, a CPU, and a memory that are linked via a bus, the CPU launching a mount reservation module on the memory and, based on the storage session information collected from each storage apparatus, only when disk resources used by a computer are released, performs mount control for permitting other computers to mount the disk resources.

16. A mount reservation server according to claim 15, wherein
upon receiving a message from the storage apparatus, the CPU reflects the content of the message in an access status list recorded for each storage resource.

17. A mount reservation server according to claim 15, wherein
upon receiving a mount request from a management server, the CPU reflects the content of the mount request in a mount reservation list recorded for each storage resource while controlling order of reservation.

18. A mount reservation server according to claim 15, wherein
the CPU controls order of reservation in accordance with reservation time or in accordance with priority of the computer or storage apparatus.

19. A mount reservation server according to claim 15, wherein
the CPU receives a message from the storage apparatus,
when the content of the message indicates access-in-progress, the CPU does not meet mount requests of other computers, and
when the content of the message indicates access-stopped, the CPU transmits a message of mount permission to another computer that has a reservation for relevant storage resources next in a mount reservation list, and the CPU deletes the reservation of the relevant host from the mount reservation list.

20. A mount reservation server according to claim 15, wherein
in response to a mount request by a computer having a high priority, the CPU performs mount control for transmitting an unmount request to mounting computers having lower priorities to release already mounted disk resources and for granting mount permission to the computer having the high priority.

21. A mount reservation server according to claim 15, wherein
the CPU transmits a scope definition to the storage apparatus, the scope definition defining a scope of disk resources, and
based on change of an access status communicated from the storage apparatus in response to release of disk resources in the scope defined in the scope definition, the CPU performs mount control for permitting mounting of the disk resources in the scope defined in the scope definition.
